(19) United States
(12) Patent Application Publication
(10) Pub. No.: US 2002/0180580 A1
(43) Pub. Date: Dec. 5, 2002

(54) Package receiving system and method

(76) Inventor: Bradley L. Gotfried, Hobe Sound, FL (US)

Correspondence Address: AKERMAN, SENTERFITT & EIDSON, P.A., Esperante Building, Suite 400, 222 Lakeview Avenue, Post Office Box 3188, West Palm Beach, FL, 33402-3188, US

(21) Appl. No.: 09/867,939

(22) Filed: May 30, 2001

(51) Int. Cl. H04Q 1/00

(52) U.S. Cl. 340/5.2; 70/277; 109/53; 109/23

(57) ABSTRACT

The present invention relates to a system and method for receiving packages. The system includes a housing having a plurality of walls forming an enclosure. At least one of the compartments is unequal in size relative to the other compartments. The compartments can concurrently house packages of varying sizes. A plurality of lockable doors disposed in the housing provides access to at least one of the compartments in the housing. The locks are switchable between a locked condition and an unlocked condition using at least one authorization code.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF INVENTION

1. Field of the Invention

The present invention relates generally to a system and method for receiving packages, and more particularly to a system and method for receiving numerous packages concurrently in a storage device.

2. Description of the Related Art

Individuals and businesses order significant quantities of products that they expect to be delivered by mail delivery service providers, such as Federal Express, United Parcel Service, and the United States Post Office. The quantity of products delivered to homes and businesses has steadily increased in recent years, caused in part by the convenience of computer communications networks such as the Internet. As a result, heavy demands have been placed upon mail delivery service providers to accommodate the increased delivery requirements. Mail delivery service providers often encounter difficulties in delivering the increased number of products. These difficulties include attempting to deliver packages to individuals who are not at home, and attempting to deliver packages to mailboxes which are not appropriately sized to receive the packages.

Many attempts have been made to assist individuals regarding the secure delivery of items by mail delivery service providers to storage devices. For example, U.S. Pat. No. 5,774,053 to Vagra discloses a storage device using a communication apparatus to facilitate ordering over the Internet. Additionally, U.S. Pat. No. 5,979,750 to Kindell discloses computer-controlled access by delivery personnel to a delivery box. While many devices are known in the prior art for the storage of delivered items, there is a need for a system and method that allows for the concurrent storage of several packages of different sizes, while also providing security for stored packages.

### SUMMARY OF THE INVENTION

A system for receiving packages, according to one embodiment of the invention, includes a housing. The housing has a plurality of compartments, in which at least one of the compartments is unequal in size relative to the other compartments. The system also has a plurality of doors connected to the housing. The doors provide access to at least one of the compartments. At least one of the doors is switchable between an open condition and a closed condition. The system also has input structure configured to recognize an authorization code, and an access controller in communication with the doors and/or the input structure. The access controller can selectively switch at least one of the doors to the open condition upon receipt of a correct authorization code.

At least one of the doors switched to the open condition by the access controller can be selected based upon characteristics of a package to be delivered. The characteristics can include the physical dimensions of the package to be delivered. Additionally, at least one of said doors can have an electronically controlled lock.

The authorization code can include an access code and an address designator, in which the address designator identifies at least one of the compartments to which a package is to be delivered, and the access code is communicated to the access controller, allowing access to said at least one compartment defined by said address designator by switching a door of at least one said compartment to the open condition. The access controller can be a microprocessor which is programmable to selectively switch at least one of the compartments to the open condition upon receipt of the correct authorization code.

According to the invention, the access controller can be electronically coupled to a remotely located computer, allowing the access controller to be programmed from said computer at the remote location. The system can also have a communication structure operatively coupled to the access controller. The communication structure allows the access controller to be programmed from a remote location. Additionally, the authorization code can be modified from a remote location, and at least one authorization code can be deactivated after at least one of the doors is switched to an open condition.

The system can also have an indicator coupled to the access controller, which indicates when a package has been delivered to at least one of the compartments. The indicator can be a visual indicator and/or an audio indicator. Examples of acceptable visual indicators include an indicator light and/or a light-emitting diode display. Examples of acceptable audio indicators include structure which generates sound relating to a delivered package. According to the invention, the access controller can be connected to a wireline and/or a computer communications network.

The system can also have structure which recognizes machine readable indicia affixed to the package to be delivered. The machine readable indicia can include the authorization code. Additionally, the machine readable indicia can include a bar code.

According to the invention, the input structure can be a keypad. Alternatively, the input structure can be an optical scanning device, the authorization code can be indicia readable by an optical scanning device, and the optical scanning device can be a bar code reader. The authorization code can be a bar code or alphanumeric. In addition, at least one of the compartments can include an indicator light.

According to another embodiment of the invention, the access controller can be a microprocessor, and the microprocessor can have has a plurality of memory locations corresponding to said compartments. In this arrangement, the microprocessor can have a program to perform operations, including storing an access code in a memory location, in which the memory location is associated with an address corresponding to a target compartment to which a package is to be delivered. The program can also accept an input authorization code from the input structure, in which the input authorization code includes an access code and an address designator corresponding to a target compartment, compare the access code from the input authorization code to the stored access code associated with the target address, and open the compartment corresponding to the target address if a match exists.

In another arrangement, the access controller can be a microprocessor, and the microprocessor can include a program to perform operations, including storing a first authorization code in a memory location, assigning the first authorization code to a compartment, accepting a second authorization code from the input structure, comparing the second authorization code to determine if a match exists, and switching the compartment assigned to the first authorization code to an open condition if a match exists. In this arrangement, the authorization code can include the physical dimensions of a package to be delivered, and the program can further include selecting a compartment based on the dimensions of the package to be delivered.

In another arrangement of the invention, the access controller can be a microprocessor, and the microprocessor includes a program to perform operations, including storing a first authorization code in a memory location, selecting a compartment to receive a package based upon dimensions of the package to be delivered, assigning the selected compartment to the first authorization code, accepting a second authorization code from a input structure, comparing the second authorization code to determine if a match exists, and switching the component assigned to the first authorization code to an open condition if a match exists.

In yet another arrangement, the access controller can be a microprocessor, in which the microprocessor includes a program to perform operations, including storing a first authorization code in a memory location, accepting a second authorization code from a input structure, in which the second authorization code includes the physical dimensions of a package to be delivered, selecting a compartment to receive a package based on the dimension of the package to be delivered, comparing the input authorization code to the authorization code stored in the memory to determine if a match exists, and switching the compartment to an open condition if a match exists.

The system according to the invention can include a computer configured to be in communication with a vendor at a remote location. The computer can include a program to perform operations, including receiving an authorization code from a vendor at a remote location and transmitting the authorization code to the access controller, whereby the authorization code is stored in the memory of the access controller and the access controller is programed to switch the compartment to an open condition when the authorization code is recognized by the input structure.

In accordance with the inventive arrangements, the system can have a computer configured to be in communication with a vendor, in which the computer includes a program to perform operations, including receiving an authorization code from a remotely located vendor, receiving physical dimensions of a package to be delivered from the remotely located vendor, and communicating the authorization code and the physical dimensions of the package to be delivered to the access controller.

Another arrangement of the invention relates to a method for receiving packages in a storage device, which includes sending to the storage device characteristics of a package to be delivered to the storage device, selecting a compartment of te storage device to receive the package based upon the characteristics of the package, assigning an authorization code to the selected compartment, storing the authorization code, accepting an input authorization code, comparing the stored authorization code to the input authorization code, switching the compartment to an open condition and storing the package in the compartment if the storage authorization code matches the input authorization code. The characteristics can include the physical dimension of the package to be delivered.

In another arrangement, the invention relates to a method for receiving packages in a storage device, including the steps of sending an authorization code to the storage device, storing the authorization code, accepting an input authorization code, comparing the stored authorization code with the input authorization code, and switching the compartment to an open condition and storing the package in the compartment, if the stored authorization code matches the input authorization code.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 shows a perspective view of a storage device system according to the invention.

FIG. 2 shows a front view of a storage device system according to the invention.

FIG. 3 shows a block diagram of a storage device system according to an embodiment of the invention.

FIG. 4 shows a block diagram of a storage device system according to an alternative embodiment of the invention.

FIG. 5 shows a schematic representation of a storage device system according to the invention in communication with a vendor via a computer communications network.

FIG. 6 shows a schematic representation of a storage device system according to the invention in communication with a vendor via a wireline.

FIG. 7 is a flow diagram of a method according to the invention.

FIG. 8 is a flow diagram of a method according to the invention.

### DETAILED DESCRIPTION OF THE PREFERRED EMBODIMENTS

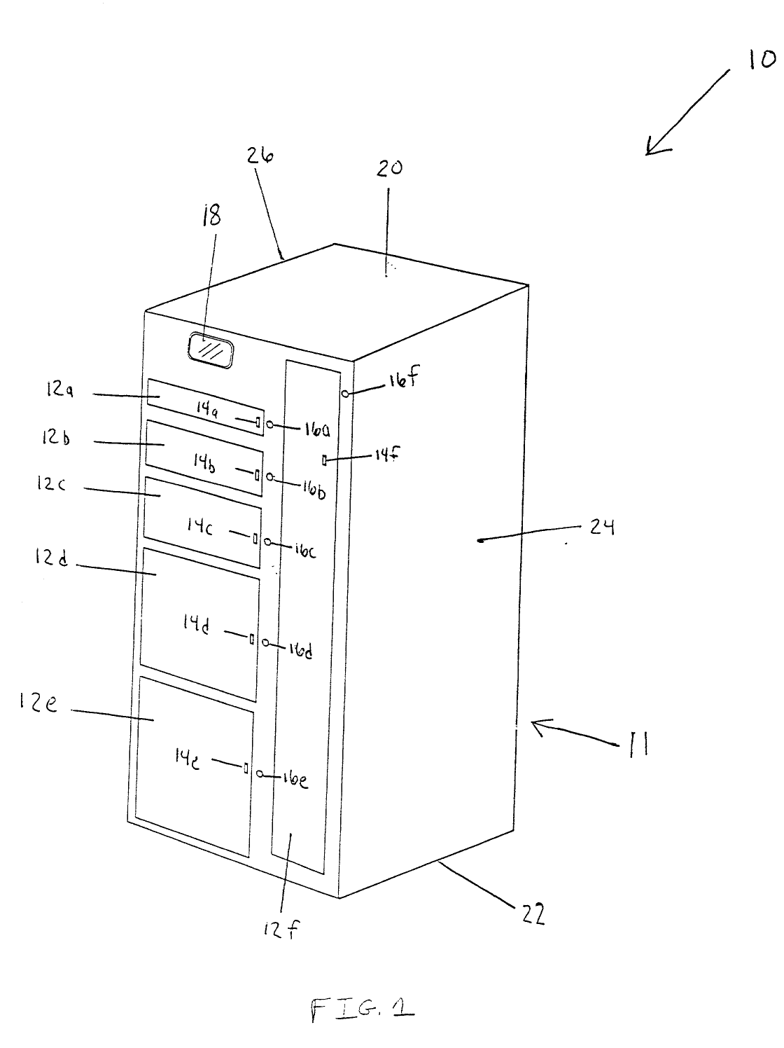

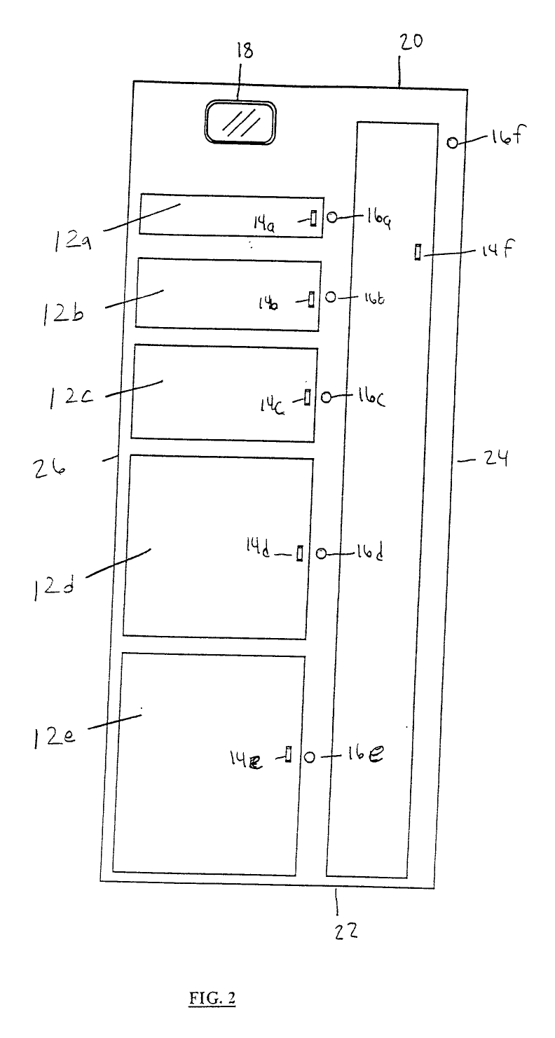

The present invention relates to a system and method for receiving packages. As shown in FIGS. 1 and 2, the system 10 includes a housing 11 which can be configured to concurrently receive packages from multiple sources. The housing 11 has an upper wall 20, a lower wall 22 and side walls 24, 26. A plurality of compartments 12a-12f can be integrated into the housing 11. The compartments 12a-12f allow various packages to be received and stored by the system 10. At least one of the compartments 12a-12f can be unequal in size relative to the other compartments 12a-12f to enable packages of unequal size to be concurrently housed in the system. For example, laundry delivered by a dry cleaning service can be stored in one of the compartments 12a-12f, while a letter or a box can be concurrently stored in a different compartment 12a-12f. It is understood that the compartments 12a-12f can be any suitable shape or size, and that any number of compartments 12a-12f can be identical in shape and/or size.

Each of the compartments 12a-12f can have a door with at least one lock 14a-14f for preventing access to the compartments 12a-12f. The locks 14a-14f can be switched between open and closed positions in any suitable manner, such as mechanically or electronically. Additionally, the locks 14a-14f can be individually or jointly switched between different conditions.

The system 10 can also have one or more indicators 16a-16f that indicate whether an item has been delivered to one or more compartments 12a-12f. The indicators 16a-16f may indicate delivery of a package in any suitable manner, such as with a visual device or an audio device. For example, the indicators 16a-16f can be a light-emitting diode display or a flashing light displayed on any portion of the system 10, such as the compartment 12a-12f to which a package has been delivered. In another example, the indicators 16a-16f can be an audio device that can generate sound indicating that a package has been delivered. The generated sound can be any suitable sound, such as an intermittent beep or a sound that replicates a voice. If the generated sound is a sound that replicates a voice, the sound can announce information relating to the package or the delivery of the package, such as the type of package delivered, the time of delivery of the package, and the compartment 12a-12f to which the package was delivered. Announced information can also relate to a package that is scheduled to be delivered, but has not yet been delivered.

Access to the compartments 12a-12f can be achieved by providing an authorization code to an input device 18. For example, providing the correct authorization code can open an individual lock 14a-14f or a group of locks 14a-14f. The input device 18 can be any device suitable for allowing manual or electronic entry of an authorization code. For example, if the authorization code is alphanumeric, the input device 18 can be a keypad. Alternatively, the input device 18 can be a device capable of reading machine readable indicia, such as a bar code affixed to a package. In such an embodiment, the input device 18 can recognize machine readable indicia in any suitable manner, such as by scanning or otherwise reading the machine readable indicia. The machine readable indicia can include the authorization code.

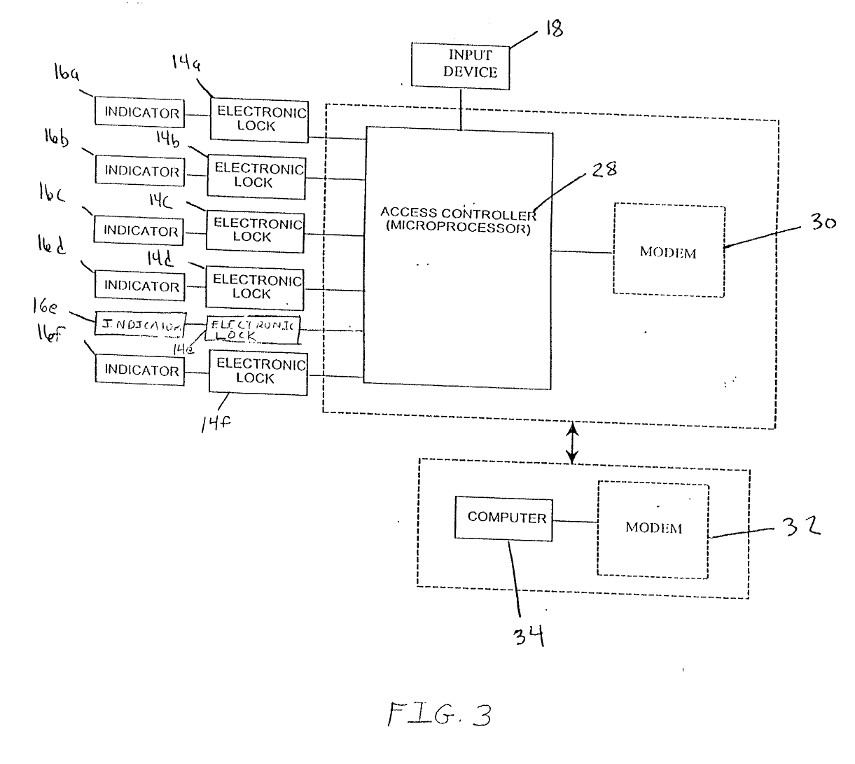

FIG. 3 shows a block diagram of the system 10 according to an embodiment of the invention. In the example of FIG. 3, the system 10 includes an access controller 28 in communication with the locks 14a-14f and the input device 18. The access controller 28 can be a microprocessor, as shown in FIG. 3, although the invention is not limited in that regard. The access controller 28 can include a memory, which can store information relating to packages to be delivered to the system 10. The memory can also store information relating to the system 10, including but not limited to the compartments 12a-12f, the locks 14a-14f, and the indicators 16a-16f.

The access controller 28 can selectively lock, unlock, open or close an individual or group of compartments 12a-12f when the system 10 is provided with a correct authorization code. For example, when the system 10 recognizes a correct authorization code, one or more compartments 12a-12f can be opened or unlocked based upon a characteristic of the package to be delivered, such as the size of the package.

As shown in FIG. 3, the system 10 can include a modem 30, which allows information to be transmitted and received via the access controller 28. The operation of the modem 30 can permit the access controller 28 to be programmed from a remote location. Programming the access controller 28 from a remote location via the modem 30 allows a vendor to assist in determining the target compartment 12a-12f for a package to be delivered. In addition, the modem 30 can allow for faster and more efficient delivery of packages.

For example, a vendor may communicate with the access controller 28 via any suitable computer communications network using the modem 30, and send the authorization code to the access controller 28. The computer communications network can be, but is not limited to, any privately or publicly accessible network. For example, the privately and publicly accessible networks can include any number or combination of the following: local area networks, wide area networks, metropolitan area networks, and global area networks. The Internet and Bitnet are examples of global area networks. Examples of privately accessible networks include America Online®, Compuserve®, and Prodigy®. It is understood that the invention is not limited to any of these examples, as any other computer communications network is also acceptable.

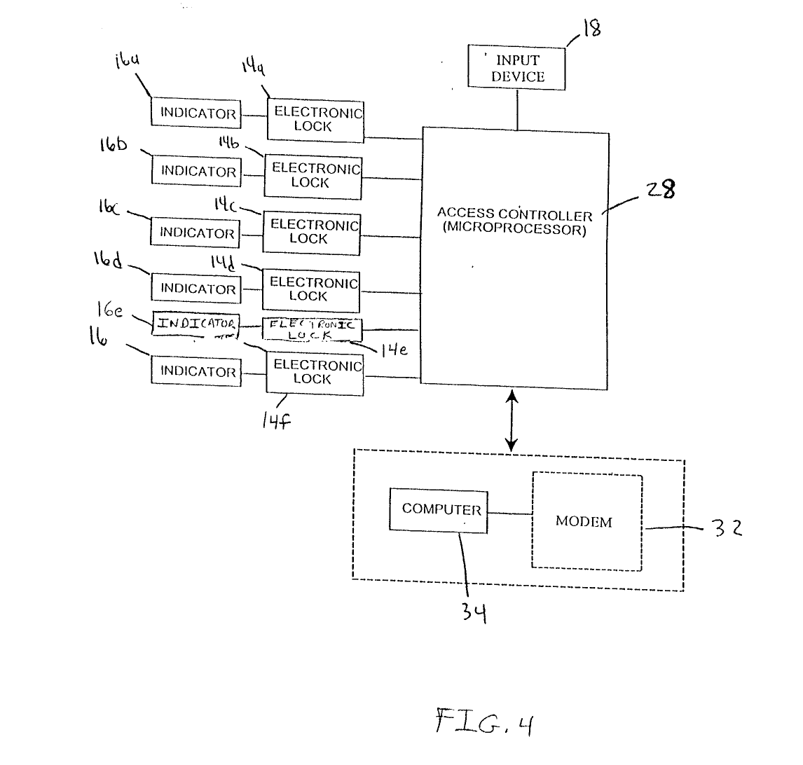

As shown in FIG. 4, the access controller 28 may be electronically coupled to a computer 34 at a remote location, allowing the access controller 28 to be programmed from the computer 34 at a remote location via a modem 32. After the authorization code is recognized by the input device 18, the corresponding lock 14a-14f can be switched from the closed position to the open position. Once the appropriate lock 14a-14f is switched to an open condition, one or more indicators 16a-16f can indicate that a package has been delivered to at least one of the compartments 12a-12f. The indicators 16a-16f can be coupled to the access controller 28.

The access controller 28 can also have a program to perform operations such as storing an authorization code associated with the components 12a-12f. The program can accept an authorization code from the input device 18. The entered authorization code can include an access code and an address designator corresponding to a target compartment 12a-12f to which a package is to be delivered. The program can compare the access code from the authorization code to the stored access code associated with the target component 12a-12f. For example, if an authorization code is entered that has dimensions suitable for compartment 12e in FIG. 1, the appropriate authorization code can include an access code and address designator causing the opening of the compartment 12e. Such an arrangement allows the delivered package to be stored in the most appropriate compartment based on characteristics of the package being delivered, such as the physical dimensions of the package.

The access controller 28 may store a first authorization code in memory, assign a compartment 12a-12f to the first authorization code, and accept a second authorization code from an input device 18. After accepting the second authorization code, the second authorization code can be compared to the first authorization code to determine if a match exists. If a match exists, a compartment 12a-12f can be unlocked or otherwise opened. In this arrangement, the authorization code can include a designation of the compartment 12a-12f to which the package is to be delivered. Alternatively, the authorization code may include the physical dimensions of the package to be delivered, without designating the compartment 12a-12f to which the package is to be delivered. In this example, the system 10 can select a compartment 12a-12f based upon characteristics of the package to be delivered such as the physical dimensions of the package.

Another embodiment of the invention allows the vendor to provide characteristics such as physical dimensions of the package prior to delivery. In this embodiment, a compartment 12a-12f can be selected before actual delivery. In yet another embodiment of the invention, the dimensions are included in the authorization code at the time of delivery. Thus, the compartment 12a-12f to receive the package is selected at the time of delivery.

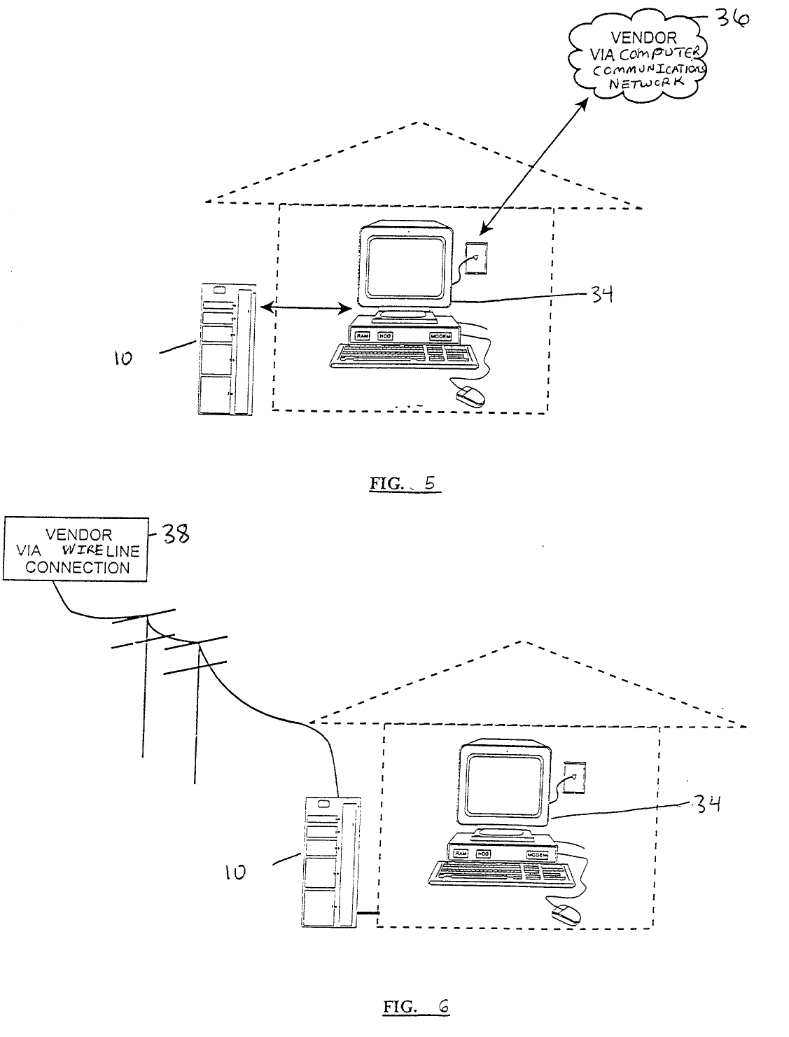

As shown in FIG. 5, the system 10 can be connected to a computer 34. The computer 34 can be configured to be in communication with a vendor at a remote location via a computer communications network 36. Communicating with a vendor via a computer communications network 36 allows the transmission of authorization information from the vendor to the system 10. Accordingly, the computer 34 can be configured to include a program to perform operations, such as providing an authorization code to the access controller 28. The authorization code can be stored in the memory of the access controller 28 and the access controller 28 can be programmed to unlock or otherwise open a selected compartment 12a-12f when the authorization code is provided to the input device 18.

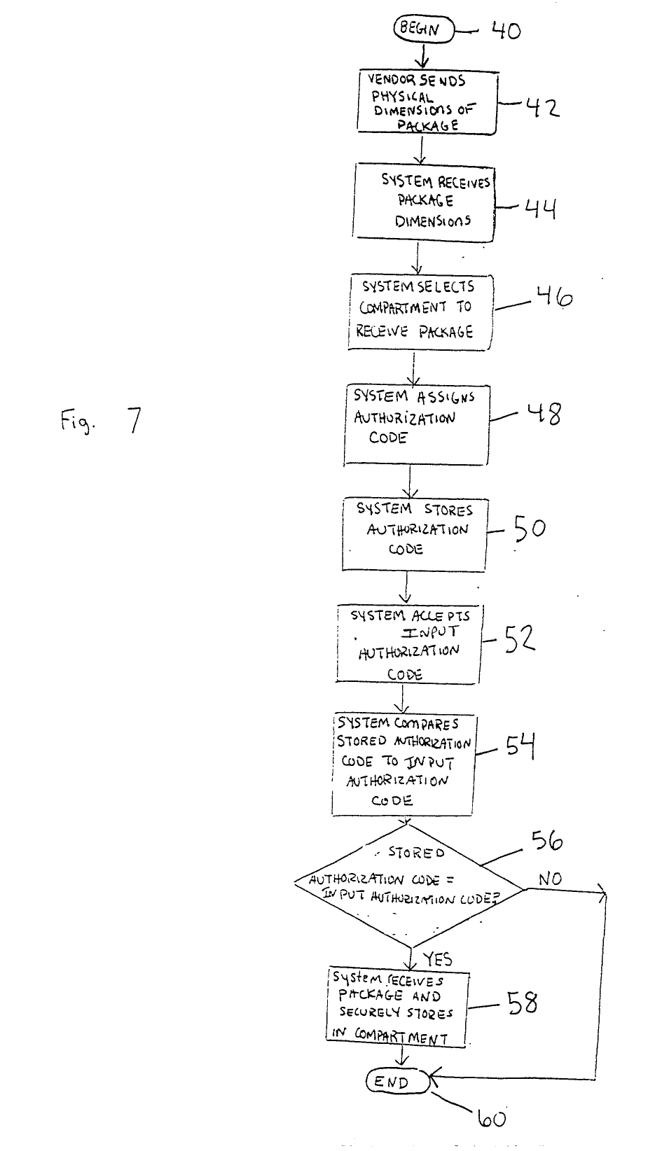

As shown in FIG. 6, the computer 34 can also be configured to be in communication with a vendor via wireline connection 38. In this example, the computer 34 can have a program to perform operations, such as receiving an authorization code from a vendor at a remote location, receiving physical dimensions of a package to be delivered from a vendor at a remote location, and communicating the authorization code and the characteristics of the package to be delivered to the access controller 28.

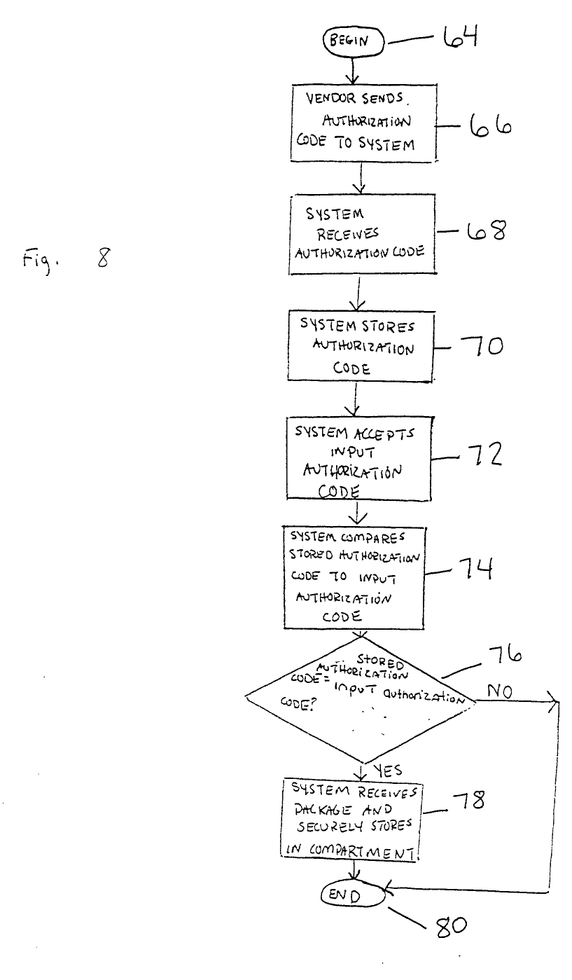

FIG. 7 shows a method in which information relating to a delivery, or a package to be delivered, can be provided to and processed by the system 10. In the example of FIG. 7, physical dimensions of a package are processed by the system 10. It is understood, however, that the invention is not limited in this regard, as any suitable information can be processed. The method begins at step 40. Afterwards, according to step 42, a vendor can send information relating to a delivery or a package to be delivered, such as the physical dimensions of the package, to the system 10. For example, a vendor can send only the physical dimensions of the package without any other information relating to the delivery of the package. The vendor can send information to the system 10 using a computer communications network, a wireline, or any other communications mechanism connection. After the information has been sent by the vendor, step 44 allows the information to be received by the system 10. The physical dimensions of the package can be received by the access controller when this information reaches the system 10. After receipt of the information by the system 10, according to step 46, a compartment 12a-12f can be selected to receive the package. In step 46, the compartment selected can be based upon the dimensions of the package. For example, if the dimensions of the package were equivalent to those of a letter, the system can select a compartment 12a-12f suited for storage of a letter. Alternatively, if the dimensions were more suited for a larger compartment, the system 10 can select an appropriately sized larger compartment 12a-12f. Once the compartment 12a-12f has been selected, the system 10 can proceed to step 48 and assign an authorization code to the package. The authorization code assigned in step 48 can be representative of the compartment 12a-12f suitable for storage of the package.

According to step 50, the system 10 can store the authorization code assigned to the package as a stored authorization code. The authorization code can be stored in the access controller 28 of the system 10 and correspond with a particular compartment 12a-12f. In step 52, the system 10 can accept an input authorization code that authorizes entry into the system 10. The input authorization code can be provided to the system 10 using an input device. According to step 54, the input authorization code that is entered can be compared to the stored authorization code. According to step 56, the system 10 can unlock the corresponding compartment 12a-12f if the stored authorization code is equivalent to the input authorization code. In step 58, the unlocked compartment can receive a package and securely store the package in the compartment 12a-12f. After the package is properly delivered to the appropriate compartment 12a-12f, the process ends at step 60. If the stored authorization code does not match the input authorization code, the assigned compartment 12a-12f does not open, and the process ends according to step 60.

FIG. 8 shows another method in which information relating to a delivery or a package to be delivered can be provided to and processed by the system 10. In the example of FIG. 8, the authorization code may be sent to the system via a computer communications network, a wireline, or any other suitable communication mechanism, according to step 66. The authorization code can include an access code and an address designator. The address designator can identify the compartment to which a package is to be delivered. In step 68, the system 10 can receive an authorization code via the access controller 28. As indicated in step 70, the authorization code can be stored in the memory of the access controller 28. The stored authorization code can correspond to a specific compartment 12a-12f, which can be represented by the address designator component of the authorization code. The system 10 can be programmed to selectively open and unlock a specified compartment 12a-12f upon the entry of an input authorization code. In step 72, upon entry of an input authorization code, the system 10 can compare the input authorization code to the stored authorization code. In step 74, the input authorization code can be compared to the stored authorization code. According to step 76, if the stored authorization code is equivalent to the input authorization code, the system 10 can unlock or otherwise open the assigned compartment 12a-12f indicated by the authorization code. In step 78, the system 10 can receive and securely store the package in an appropriate compartment 12a-12f. After the package is secured stored, the system 10 proceeds to step 80, ending the delivery process. If the stored authorization code does not match the input authorization code, according to step 76, the system 10 will not unlock a corresponding compartment 12a-12f. Instead of unlocking a compartment 12a-12f, the system 10 will end the delivery process by proceeding to step 80.

It should be understood that the examples and embodiments described herein are for illustrative purposes only and that various modifications or changes in light thereof will be obvious to persons skilled in the art and are to be included within the spirit and purview of this application. Moreover, the invention can take other specific forms without departing from the spirit or essential attributes thereof.

What is claimed is:

1. A system for receiving packages, comprising:
a housing, said housing having a plurality of compartments wherein at least one of said compartments is unequal in size relative to said other compartments;
a plurality of doors connected to said housing, wherein said doors provide access to at least one of said compartments and wherein at least one of said doors is switchable between an open condition and a closed condition;
input structure configured to recognize an authorization code; and
an access controller in communication with at least one of said doors and said input structure, wherein said access controller can selectively switch at least one of said doors to the open condition upon receipt of a correct authorization code.

2. The system of claim 1, wherein at least one of said doors switched to the open condition by said access controller is selected based upon characteristics of a package to be delivered.

3. The system of claim 2, wherein the characteristics comprise the physical dimensions of the package to be delivered.

4. The system of claim 1, wherein at least one of said doors has an electronically controlled lock.

5. The system of claim 1, wherein said authorization code includes an access code and an address designator, wherein said address designator identifies at least one of said compartments to which a package is to be delivered, and said access code is communicated to said access controller, allowing access to said at least one compartment defined by said address designator by switching a door of at least one said compartment to the open condition.

6. The system of claim 1, wherein said access controller is a microprocessor, and wherein said access controller is programmable to selectively switch at least one of said compartments to the open condition upon receipt of the correct authorization code.

7. The system of claim 1, wherein said access controller is electronically coupled to a remotely located computer, allowing said access controller to be programmed from said computer at the remote location.

8. The system of claim 7, further comprising a communication structure operatively coupled to said access controller, wherein said communication structure allows said access controller to be programmed from a remote location.

9. The system of claim 1, wherein said authorization code can be modified from a remote location.

10. The system of claim 1, wherein said at least one authorization code is deactivated after at least one of said doors is switched to an open condition.

11. The system of claim 1, further comprising an indicator coupled to said access controller, whereby said indicator indicates when a package has been delivered to at least one of said compartments.

12. The system of claim 11, wherein said indicator comprises at least of a visual indicator and an audio indicator.

13. The system of claim 12, wherein said visual indicator comprises at least one of an indicator light and a light-emitting diode display.

14. The system of claim 12, wherein said audio indicator generates sound relating to a delivered package.

15. The system of claim 1, further comprises machine readable indicia affixed to the package to be delivered, wherein said machine readable indicia includes the authorization code.

16. The system of claim 15, wherein said machine readable indicia comprises a bar code.

17. The system of claim 1, wherein said access controller is connected to at least one of a wireline and a computer communications network.

18. The system of claim 1, wherein said input structure is an optical scanning device.

19. The system of claim 18, wherein the said authorization code is indicia readable by an optical scanning device.

20. The system of claim 19, wherein said optical scanning device is a bar code reader, and the authorization code is a bar code.

21. The system of claim 1, wherein the said input structure is keypad.

22. The system of claim 1, wherein the authorization code is alphanumeric.

23. The system of claim 1, wherein at least one of the said compartments comprises an indicator light.

24. The system of claim 1, wherein said access controller is a microprocessor, said microprocessor has a plurality of memory locations corresponding to said compartments, and said microprocessor includes a program to perform operations comprising:
storing an access code in a memory location, the memory location being associated with an address corresponding to a target compartment to which a package is to be delivered;
accepting an input authorization code from said input structure, the input authorization code including an access code and an address designator corresponding to a target compartment;
comparing the access code from the input authorization code to the stored access code associated with the target address; and
opening the compartment corresponding to the target address if a match exists.

25. The system of claim 1, wherein the said access controller is a microprocessor, and said microprocessor includes a program to perform operations comprising:
storing a first authorization code in a memory location;
assigning the first authorization code to a compartment;
accepting a second authorization code from the input structure;
comparing the second authorization code to determine if a match exists; and
switching the compartment assigned to the first authorization code to an open condition if a match exists.

26. The system of claim 25, wherein the authorization code includes the physical dimensions of a package to be delivered, and said program further includes the operation of selecting a compartment based on the dimensions of the package to be delivered.

27. The system of claim 1, wherein said access controller is a microprocessor, wherein said microprocessor includes a program to perform operations comprising:
storing a first authorization code in a memory location;
selecting a compartment to receive a package based upon dimensions of the package to be delivered;
assigning the selected compartment to the first authorization code;
accepting a second authorization code from a input structure;
comparing the second authorization code to determine if a match exists; and
switching the component assigned to the first authorization code to an open condition if a match exists.

28. The system of claim 1, wherein said access controller is a microprocessor, wherein said microprocessor includes a program to perform operations comprising:
storing a first authorization code in a memory location;
accepting a second authorization code from a input structure, wherein the second authorization code includes the physical dimensions of a package to be delivered;
selecting a compartment to receive a package based on the dimension of the package to be delivered;
comparing the input authorization code to the authorization code stored in the memory to determine if a match exists; and
switching said compartment to an open condition if a match exists.

29. The system of claim 7, wherein said computer is configured to be in communication with a vendor at a remote location and said computer includes a program to perform operations comprising:
receiving an authorization code from a vendor at a remote location and transmitting the authorization code to the access controller, whereby the authorization code is stored in the memory of the access controller and the access controller is programed to switch said compartment to an open condition when the authorization code is recognized by said input structure.

30. The system of claim 7, wherein said computer is configured to be in communication with a vendor, and said computer includes a program to perform operations comprising:
receiving an authorization code from a remotely located vendor;
receiving physical dimensions of a package to be delivered from the remotely located vendor; and
communicating the authorization code and the physical dimensions of the package to be delivered to said access controller.

31. A method for receiving packages in a storage device, comprising the steps of:
sending to the storage device characteristics of a package to be delivered to the storage device;
selecting a compartment of te storage device to receive the package based upon the characteristics of the package;
assigning an authorization code to the selected compartment;
storing the authorization code;
accepting an input authorization code;
comparing the stored authorization code to the input authorization code; and
switching the compartment to an open condition and storing the package in the compartment, if the storage authorization code matches the input authorization code.

32. The method of step 31, wherein the characteristics comprise the physical dimension of the package to be delivered.

33. A method for receiving packages in a storage device, comprising the steps of:
sending an authorization code to the storage device;
storing the authorization code;
accepting an input authorization code;
comparing the stored authorization code with the input authorization code; and
switching the compartment to an open condition and storing the package in the compartment, if the stored authorization code matches the input authorization code.
